(19) United States
(12) Patent Application Publication
(10) Pub. No.: US 2021/0182477 A1
(43) Pub. Date: Jun. 17, 2021

(54) INFORMATION PROCESSING APPARATUS AND NON-TRANSITORY COMPUTER READABLE MEDIUM STORING PROGRAM

(71) Applicant: FUJI XEROX CO., LTD., Tokyo (JP)

(72) Inventor: Yasunari KISHIMOTO, Kanagawa (JP)

(73) Assignee: FUJI XEROX CO., LTD., Tokyo (JP)

(21) Appl. No.: 16/846,378

(22) Filed: Apr. 12, 2020

(30) Foreign Application Priority Data
Dec. 12, 2019 (JP) 2019-224366

(51) Int. Cl. G06F 40/186; G06F 40/106; G06K 9/00

(52) U.S. Cl. CPC G06F 40/186; G06F 40/106; G06K 9/00449; G06K 9/00463; G06K 9/00456

(57) ABSTRACT

An information processing apparatus includes a display control section that performs control for displaying a candidate for an element to be added or a corrected element based on an element constituting a document and information related to a purpose of use of the document to be created.

### CROSS-REFERENCE TO RELATED APPLICATIONS

This application is based on and claims priority under 35 USC 119 from Japanese Patent Application No. 2019-224366 filed Dec. 12, 2019.

### BACKGROUND

### (i) Technical Field

The present invention relates to an information processing apparatus and a non-transitory computer readable medium storing a program.

### (ii) Related Art

In recent years, a term conversion system that converts an input term into an appropriate term has been suggested (for example, refer to JP2018-165907A).

A server of the term conversion system disclosed in JP2018-165907A assists creation of a document such as a menu at a restaurant and includes a server storage unit that stores first term information (for example, a recipe name) and second term information (for example, a detailed recipe name) in association with each other for a first language (for example, a language usually used for food), an input processing unit that receives input information input in the first language, a conversion unit that specifies the second term information associated with the first term information corresponding to the input information, and a server communication unit that outputs the specified second term information.

### SUMMARY

In the case of creating a document by inserting an element constituting the document in a template, the document in which the element is inserted in the template does not necessarily have an appropriate balance of the size or the arrangement position of the inserted element. Thus, the document may not be used, and in general, the balance of arrangement of the inserted element needs to be adjusted again.

Aspects of non-limiting embodiments of the present disclosure relate to an information processing apparatus and a non-transitory computer readable medium storing a program capable of, in a case of creating a document, creating the document corresponding to a purpose of the created document more easily than in a case where creation of the document is assisted without considering the purpose of the created document.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus comprising a display control section that performs control for displaying a candidate for an element to be added or a corrected element based on an element constituting a document and information related to a purpose of use of the document to be created.

### BRIEF DESCRIPTION OF THE DRAWINGS

Exemplary embodiment(s) of the present invention will be described in detail based on the following figures, wherein:

FIG. 1 is a block diagram illustrating a configuration example of an information processing apparatus according to a first exemplary embodiment of the present invention;

FIG. 2 is a diagram illustrating one example of a document created by inserting an element in a layout image;

FIG. 3 is a diagram illustrating one example of a text table;

FIG. 4 is a diagram illustrating one example of a layout image information table;

FIG. 5 is a diagram illustrating one example of an object name table;

FIG. 6 is a diagram illustrating one example of a user table;

FIG. 7 is a diagram illustrating one example of a layout selection screen displayed on a display unit of a user terminal;

FIG. 8 is a diagram illustrating one example of a text selection screen displayed on the display unit of the user terminal;

FIG. 9 is a diagram illustrating one example of a post-processing text candidate selection screen;

FIG. 10 is a diagram illustrating one example of the text selection screen displayed on the display unit of the user terminal;

FIG. 11 is a diagram illustrating one example of the post-processing text candidate selection screen;

FIG. 12 is a flowchart illustrating one example of operation of the information processing apparatus according to the first exemplary embodiment of the present invention;

FIG. 13 is a block diagram illustrating a configuration example of an information processing apparatus according to a second exemplary embodiment of the present invention; and

FIG. 14 is a flowchart illustrating one example of operation of the information processing apparatus according to the second exemplary embodiment of the present invention.

### DETAILED DESCRIPTION

Hereinafter, exemplary embodiments of the present invention will be described with reference to the drawings. Constituents having substantially identical functions in each drawing will be designated by identical reference signs, and descriptions of the constituents will not be repeated.

### SUMMARY OF EXEMPLARY EMBODIMENT

An information processing apparatus according to the present exemplary embodiment includes a display control section that performs control for displaying a candidate for an element to be added or a corrected element based on an element constituting a document and information related to a purpose of use of the document to be created.

The “document” is data including a character string or an image such as a photograph, a motion picture, an illustration, or a map and may be arranged in a page region. The document may be a paper document printed on paper or a digitized electronic document. For example, the document includes a pamphlet, a flyer, a poster, a direct mail, a landing Web page, and a message card.

For example, the element constituting the document includes a text including a character string, a photograph, a motion picture, an illustration, and a map. The “element to be added” refers to an element that is to be added to a partial region of the document. The “corrected element” refers to an element to which the font size or the like of the element to be added is corrected in accordance with a constraint such as the size of the partial region of the document. The number of candidates may be one or plural.

For example, information related to the purpose of use includes a purpose including the purpose of use of the document, a purpose of creation, and an application of use, and attribute information such as the age, age group, sex, hobby, preference, job, and company characteristics (in a case where an order placer is a company) of a person related to the document (for example, an order placer, a creator, or a recipient of the document). The attribute information is one example of classification information for classifying the person related to the document.

For example, the purpose or intention of creation of the document includes the following.

(i) Sales (for example, a fair for each season or a special sale)

(ii) Guidance of Class (for example, guidance of an English conversation class or a cooking class)

(iii) Guidance of Event (for example, a workshop, a tour, a music, a movie, or a theater)

(iv) Rental Guidance (for example, guidance of service such as automobile rental or video rental)

(v) Other Guidance (for example, a menu of a restaurant) First Exemplary Embodiment

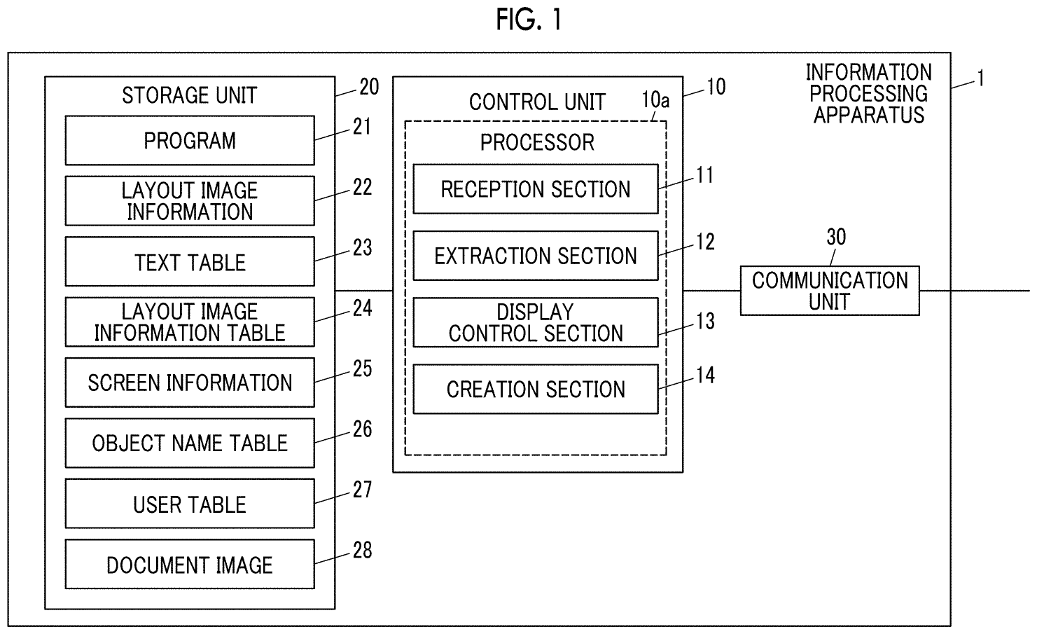

FIG. 1 is a block diagram illustrating a configuration example of an information processing apparatus according to a first exemplary embodiment of the present invention. An information processing apparatus 1 includes a control unit 10 that controls each unit of the information processing apparatus 1, a storage unit 20 that stores various information, and a communication unit 30 that communicates with an external apparatus such as a user terminal or a server through a network such as the Internet or a local area network (LAN). For example, the information processing apparatus 1 is the server and assists creation of a document by a user operating the user terminal by communicating with the user terminal.

The user terminal includes a control unit implemented by a central processing unit (CPU), an interface, and the like, a display unit implemented by a display such as a liquid crystal display, and an input unit implemented by a keyboard, a mouse, and the like. In the present exemplary embodiment, for example, the user terminal is a personal computer (PC). A program operated by the control unit includes a Web browser for browsing a Web page. The user terminal may be a portable information processing terminal such as a laptop or a mobile communication terminal such as a multifunctional mobile phone (smartphone).

The user terminal accesses the information processing apparatus 1 through the Web browser, displays various screens transmitted from the information processing apparatus 1 on the display unit, and transmits data input by the input unit to the information processing apparatus 1.

The control unit 10 is implemented by a processor 10a such as a central processing unit (CPU), an interface, and the like. The processor 10a functions as a reception section 11, an extraction section 12, a display control section 13, a creation section 14, and the like by executing a program 21. Each of the sections 11 to 14 will be described later.

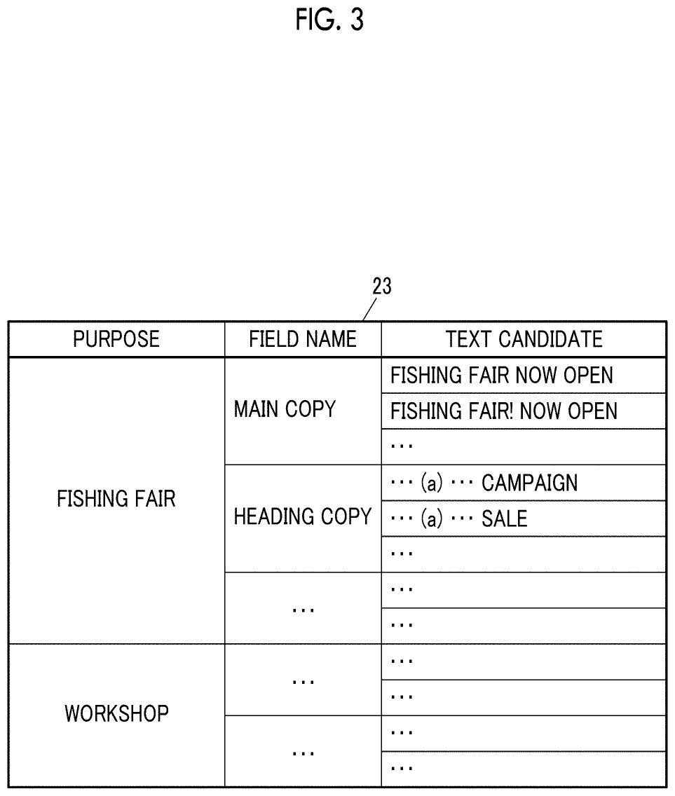

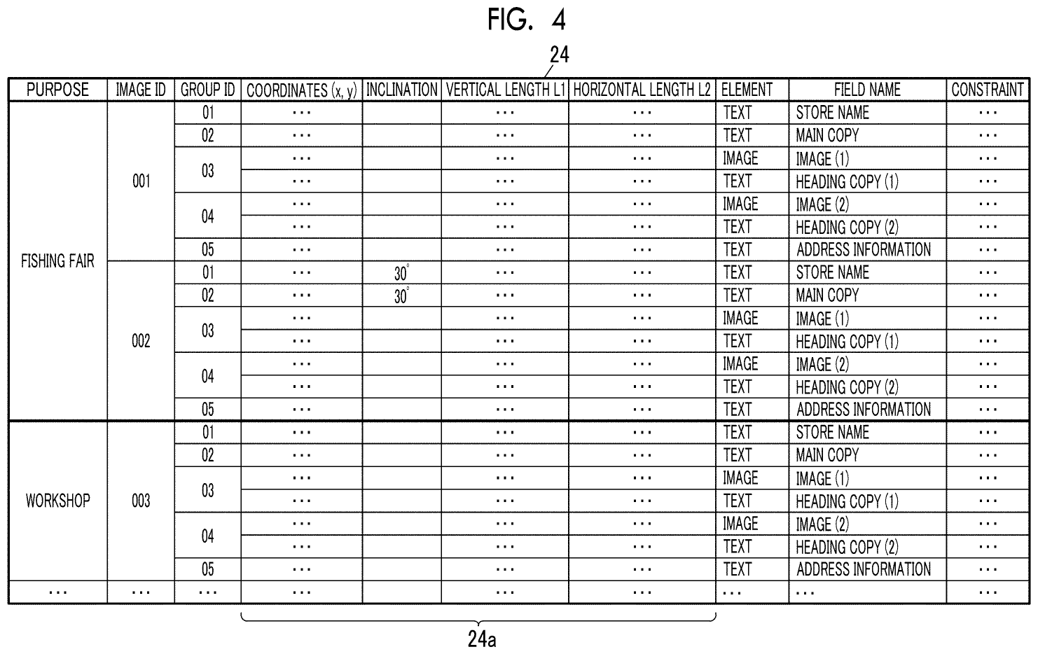

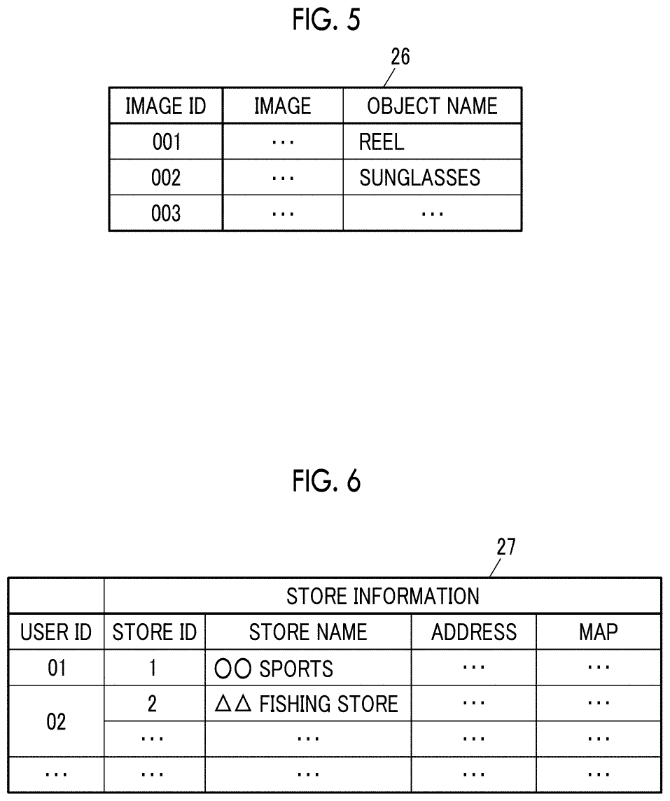

The storage unit 20 is configured with a read only memory (ROM), a random access memory (RAM), a hard disk, or the like and stores various information such as the program 21, layout image information 22, a text table 23 (refer to FIG. 3), a layout image information table 24 (refer to FIG. 4), screen information 25, an object name table 26 (refer to FIG. 5), a user table 27 (refer to FIG. 6), and a document image 28.

The layout image information 22 includes layout images 220a and 220b corresponding to a purpose (for example, a fishing fair) and an image ID for identifying a layout image. The layout image is a template of a target document.

The layout image includes a plurality of fields in which the element constituting the document is inserted. The fields include a field (hereinafter, referred to as an “operation target field”) that is an operation target of selection or the like by the user and a field (hereinafter, referred to as an “operation target exclusion field”) in which the element is inserted on the information processing apparatus 1 side without a selection operation of the user. All fields may be set as the operation target fields. The field is one example of a region in which the element is inserted.

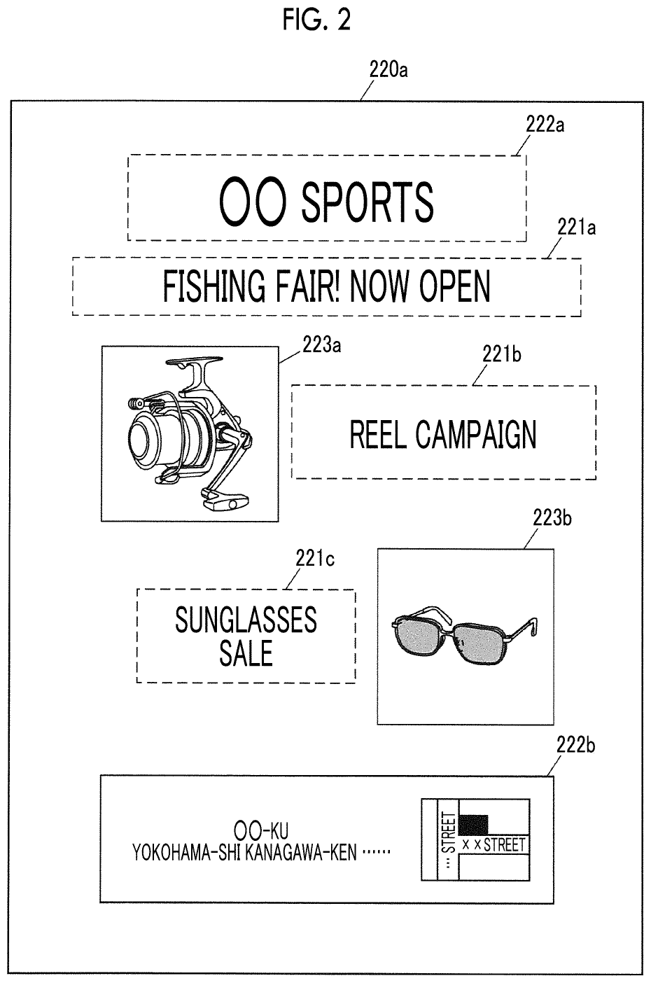

FIG. 2 is a diagram illustrating one example of a document created by inserting the element in the layout image 220a. The layout image 220a includes operation target fields 221a to 221c (hereinafter, referred to as an “operation target field 221” when collectively referred to) and operation target exclusion fields 222a, 222b, 223a, and 223b (hereinafter, referred to as “operation target exclusion fields 222 and 223” when collectively referred to). In the present exemplary embodiment, the region of the field in which each element is inserted has a rectangular shape but may have other shapes such as an ellipse and a circle.

For example, the operation target field 221 includes main copy 221a, heading copy (1) 221b corresponding to an image (1) 223a, and heading copy (2) 221c corresponding to an image (2) 223b. For example, the operation target exclusion fields 222 and 223 include a store name 222a, address information 222b, the image (1) 223a, and the image (2) 223b.

The “main copy” refers to a main catchphrase among catchphrases. The “heading copy” refers to a heading among the catchphrases.

In the present exemplary embodiment, texts recorded in the text table 23 are inserted in the main copy 221a, the heading copy (1) 221b, and the heading copy (2) 221c included in the operation target field 221. A “store name”, an “address”, and a “map” recorded in the user table 27 are inserted in the store name 222a and the address information 222b included in the operation target exclusion fields 222 and 223. Images such as a photograph, an illustration, and a map are inserted in the image (1) 223a and the image (2) 223b. The store name 222a and the address information 222b may be combined into one operation target exclusion field.

FIG. 3 is a diagram illustrating one example of the text table 23. The text table 23 includes fields such as “purpose”, “field name”, and “text candidate”. For example, the purpose of creation of the document is recorded in the field “purpose”. The operation target field 221 is recorded in the field “field name”.

A candidate of the text inserted in the operation target field 221 is recorded in the field “text candidate”. For example, the text candidate includes the following.

(i) Fixed Text Candidate

In the text candidate corresponding to a field name “main copy”, for example, a text candidate having a predetermined content such as “fishing fair now open” or “fishing fair! now open”, that is, a fixed text candidate, is recorded.

(ii) Changing Text Candidate

In the text candidate corresponding to a field name “heading copy”, for example, a text candidate that has a changing content and includes a blank (a) like “a . . . (a) . . . sale” or “ . . . (a) . . . campaign”, that is, a changing text candidate, is recorded. In the part of the blank (a), an object name that is recorded in the object name table 26 and is extracted from the image is inserted.

For example, in a case where an object name “reel” is input in the blank (a), the text candidate corresponding to the field name “heading copy” is set to a text candidate “reel campaign” 221b and a text candidate “reel sale” 221c. The reel sale and the reel campaign are examples of an element (for example, the text) of a different type from a provided element (for example, the image).

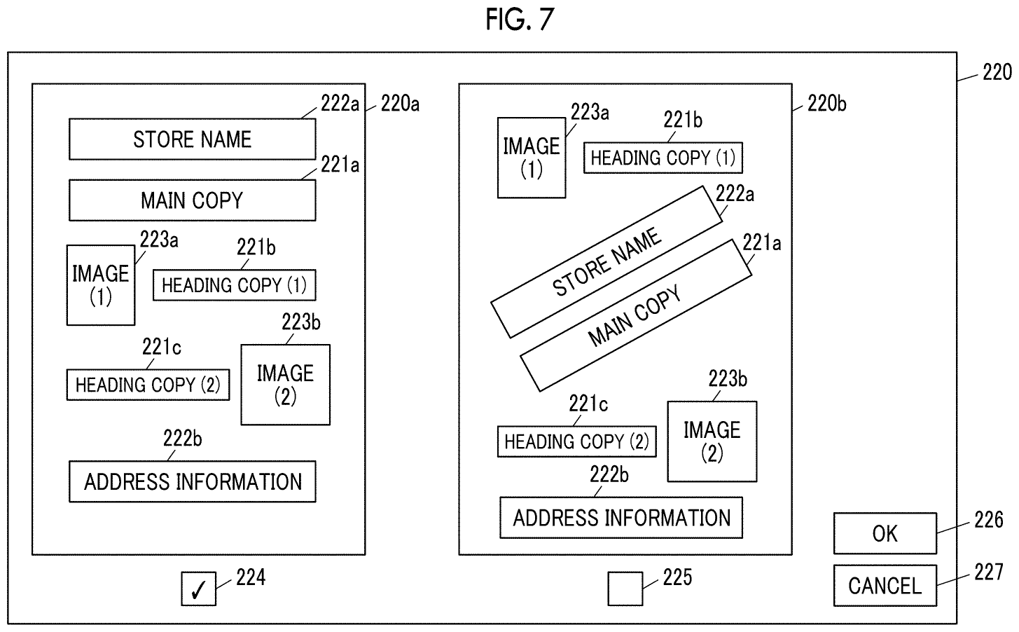

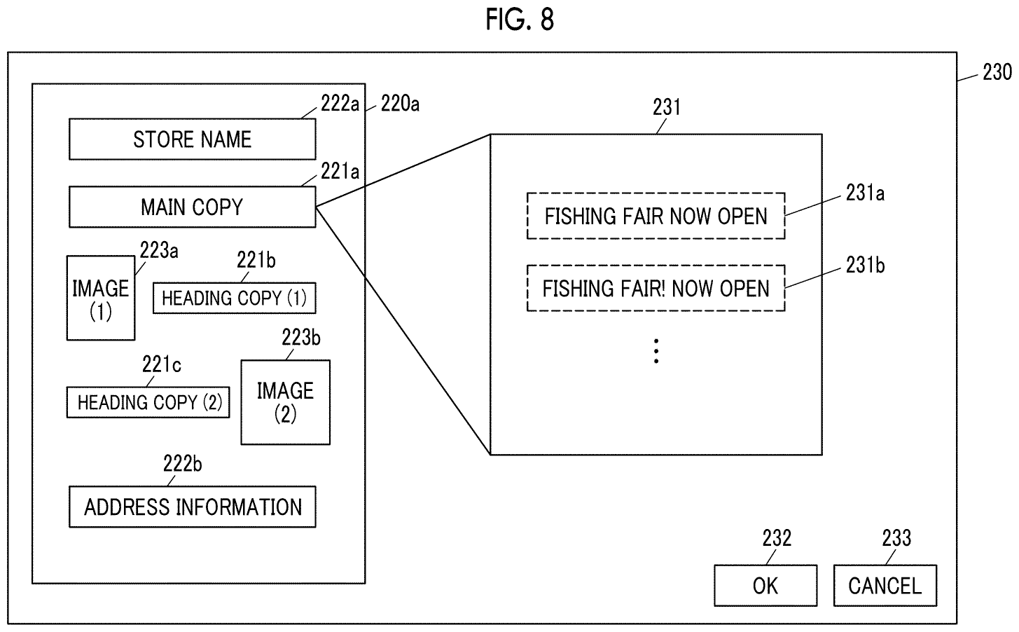

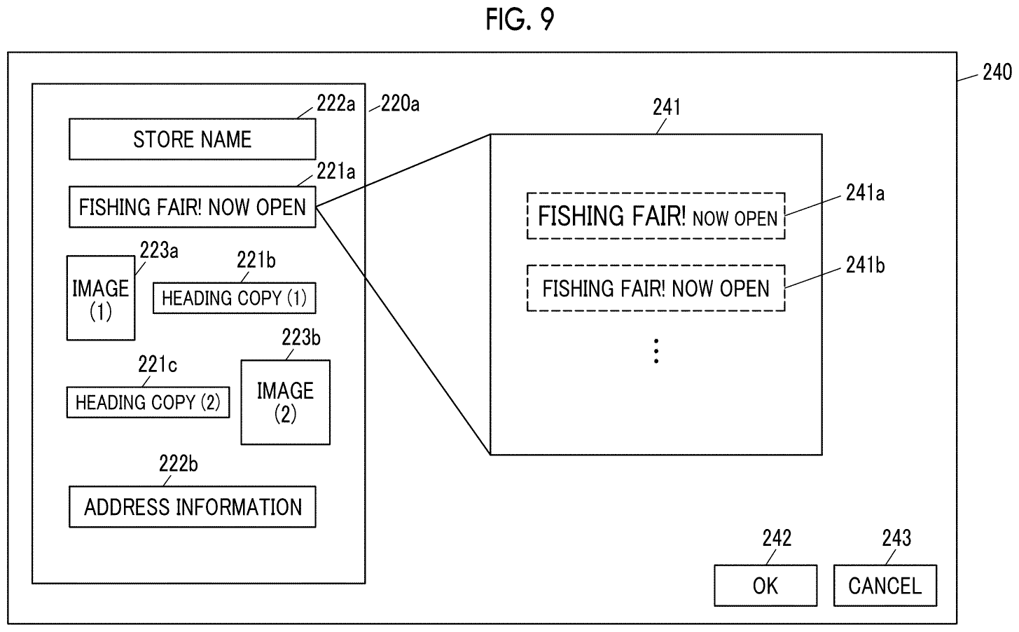

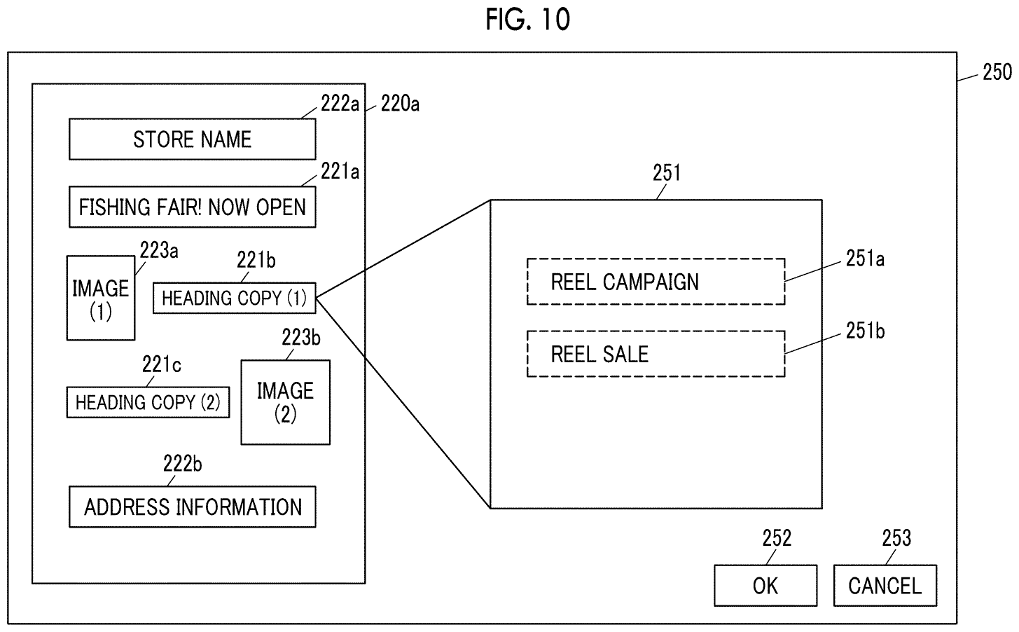

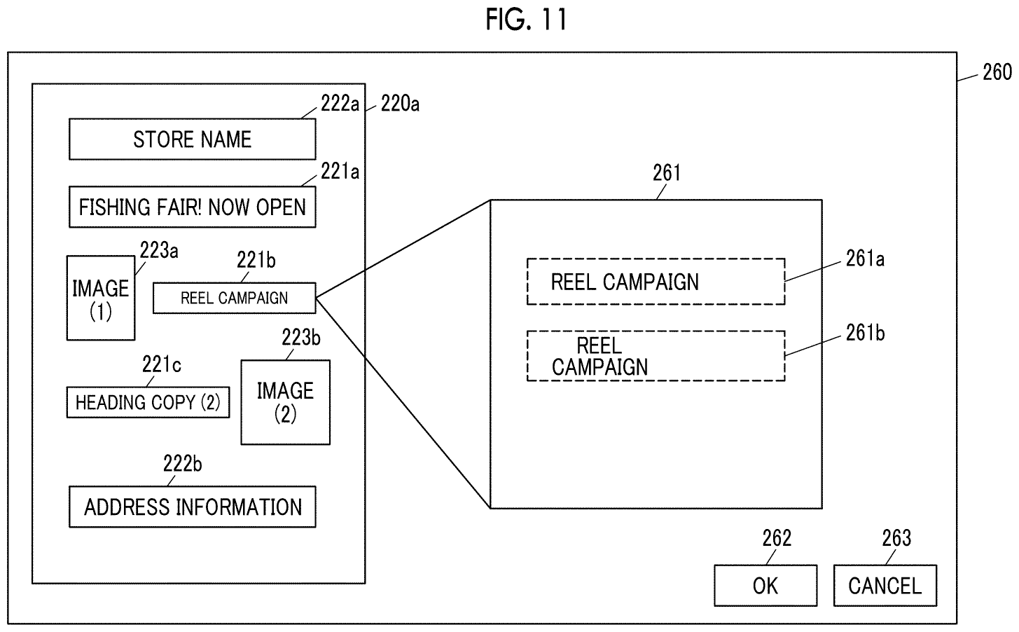

In the screen information 25, information constituting screens displayed on the display unit of the user terminal like a layout selection screen 220 illustrated in FIG. 7, text selection screens 230 and 250 illustrated in FIG. 8 and FIG. 10, and post-processing text candidate selection screens 240 and 260 illustrated in FIG. 9 and FIG. 11 is recorded.

FIG. 4 is a diagram illustrating one example of the layout image information table 24. The layout image information table 24 includes fields such as “purpose”, “image ID”, “group ID”, “coordinates”, “inclination”, “vertical length L1”, “horizontal length L2”, “element”, “field name”, and “constraint”. The meaning of the field “purpose” is the same as in FIG. 3. An image ID for identifying the layout image is recorded in the field “image ID”.

A group ID for identifying a group when relevant fields of the layout image are grouped together is recorded in “group ID”. For example, as illustrated in the layout image 220a in FIG. 2, the image (1) 223a and the heading copy (1) 221b are relevant to each other and thus, belong to one group, and the image (2) 223b and the heading copy (2) 221c are relevant to each other and thus, belong to one group.

Coordinates (x, y) of the upper left corner of a rectangular region of the field inserted in the layout image are recorded in “coordinates”. Information indicating a degree at which the rectangular region is inclined with respect to the layout image using a counterclockwise direction as a positive direction is recorded in “inclination”. The vertical and horizontal lengths of the rectangular region of the field in which the element is inserted are recorded in “vertical length L1” and “horizontal length L2”. Hereinafter, the fields “coordinates”, “inclination”, “vertical length L1”, and “horizontal length L2” will be collectively referred to as “element positional information 24a”. The type of element inserted in the field is recorded in “element”. In the present exemplary embodiment, the type of element includes the text and the image.

A condition under which the element to be inserted in the rectangular region is insertable is recorded in “constraint” in accordance with the type of element. The constraint for the text is an attribute of a character string such as the number of characters, a font type, a font size, or a type of highlight. The constraint for the image is, for example, an image size. The constraint for the text may include a case where the font sizes are different such that the font size of a part is increased and the font size of another part is decreased in order to enable the element to be inserted in the rectangular region.

FIG. 5 is a diagram illustrating one example of the object name table 26. The object name table 26 includes fields such as “image ID”, “image”, and “object name”. The image ID for identifying the image received by the information processing apparatus 1 is recorded in “image ID”. Information on the image received by the information processing apparatus 1 is recorded in “image”. The object name extracted from the image received by the information processing apparatus 1 using, for example, machine learning is recorded in “object name”.

FIG. 6 is a diagram illustrating one example of the user table 27. The user table 27 includes fields such as “user ID”, “store ID”, “store name”, “address”, and “map”. A user ID for identifying the user is recorded in “user ID”. A store ID for identifying “store name”, “address”, and “map” (hereinafter, collectively referred to as “store information”) is recorded in “store ID”. For example, information on an image showing an address of a store is recorded in the field “map”. The user ID is one example of a person related to the document and is a user who creates the document or uses or refers to the created document. The user ID, the store ID, and the store information are examples of user information.

The document image 28 is obtained by inserting the element in the region of the field of the layout image.

Next, each of the sections 11 to 14 of the control unit 10 will be described.

The reception section 11 receives a purpose and an image or a text transmitted from a user terminal 2. The reception section 11 receives the layout image and the candidate of the text selected by the user and the candidate of the text processed based on the constraint. In addition, the reception section 11 receives the user information and records the user information in the user table 27. The number of images or texts received by the reception section 11 may be one or two or more.

The extraction section 12 extracts the object name included in the image received by the reception section 11 from the image using, for example, machine learning.

The display control section 13 performs control for displaying various screens on the display unit of the user terminal as Web pages. In addition, the display control section 13 performs control for displaying a candidate of the element to be added or the corrected element on the display unit of the user terminal based on the element constituting the document and information related to the purpose of use of the document to be created.

In a case where the element to be added or the corrected element is a character string, the creation section 14 creates a first candidate of the character string based on information related to the purpose of use of the document and creates a second candidate of the character string by changing the attribute of character string in accordance with the region in which the element is inserted in the first candidate of the character string.

Operation of First Exemplary Embodiment

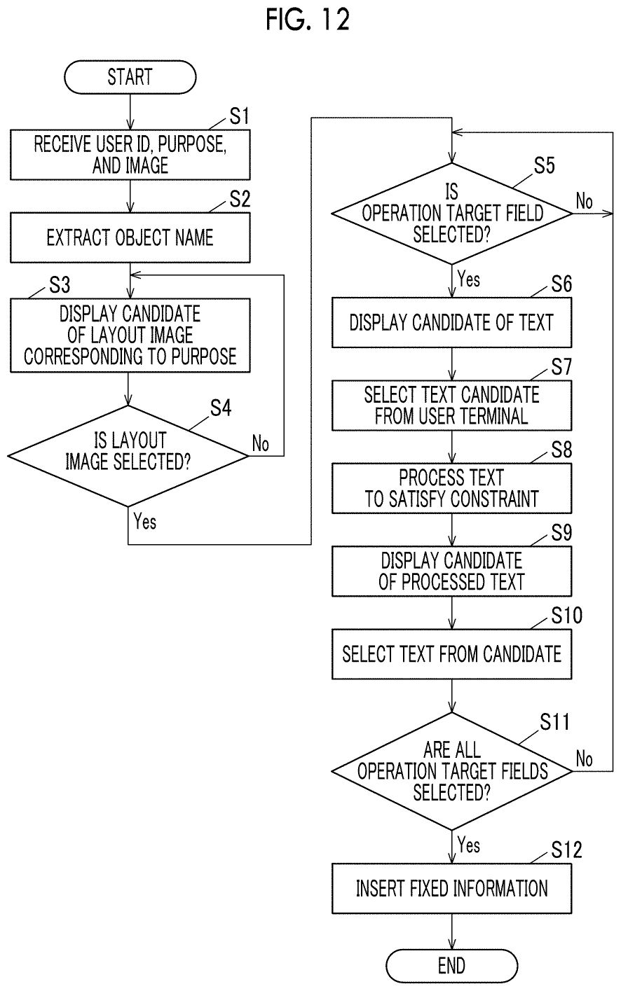

Next, one example of operation of the information processing apparatus 1 according to the first exemplary embodiment will be described with reference to FIG. 7 to FIG. 12. FIG. 12 is a flowchart illustrating one example of operation of the information processing apparatus 1 according to the first exemplary embodiment.

(1) In Case of Receiving Purpose and Image

The reception section 11 receives the purpose and the image together with the user ID from the user terminal (S1). For example, an assumption that a fishing fair is received as the purpose and two photographs in which fishing tools are captured are received as the image is made.

The extraction section 12 assigns the image ID to the photograph received by the reception section 11, extracts the object name from the photograph, and records the image ID, the photo, and the extracted object name in the object name table 26 in association with each other (S2). For example, an assumption that reel and sunglasses are extracted from the two photographs as the object name is made.

The display control section 13 reads the layout images 220a and 220b corresponding to the received purpose from the layout image information 22 and displays the layout selection screen 220 including the layout images 220a and 220b on the display unit of the user terminal (S3).

FIG. 7 is a diagram illustrating one example of the layout selection screen 220 displayed on the display unit of the user terminal. The layout selection screen 220 includes the read layout images 220a and 220b, checkboxes 224 and 225 for causing the user to select the layout images 220a and 220b, an “OK” button 226 for deciding the selected layout image, and a “cancel” button 227 for canceling selection of the layout image. The checkboxes 224 and 225 and each of the buttons 226 and 227 are selected by pointing with a cursor by operating the input unit of the user terminal.

The reception section 11 determines whether or not an operation of selecting the layout image is received from the user terminal (S4). That is, in a case where the reception section 11 determines that any one of the checkboxes 224 and 225 of the layout selection screen 220 is selected and operation of the “OK” button 226 is received (S4: Yes), the reception section 11 stores the selected layout image in the storage unit 20 as the document image 28. An assumption that the layout image 220a is selected is made.

The display control section 13 creates the text selection screen 230 including the selected layout image 220a and displays the text selection screen 230 on the display unit of the user terminal based on the document image 28 and the screen information 25.

FIG. 8 is a diagram illustrating one example of the text selection screen 230 displayed on the display unit of the user terminal. In this stage, a text selection window 231 is not displayed on the text selection screen 230. As will e described later, the text selection window 231 is displayed in a case where the user selects the operation target field 221. The text selection screen 230 includes the layout image 220a, an “OK” button 232 for deciding the selected text candidate, and a “cancel” button 233 for canceling selection of the text candidate. In a case where the user selects the main copy 221a as the operation target field 221, the text selection window 231 including text candidates 231a and 231b corresponding to the selected main copy 221a is displayed. The text candidates 231a and 231b and each of the buttons 232 and 233 are selected by pointing with the cursor by operating the input unit of the user terminal.

In FIG. 8, the operation target field 221 includes the main copy 221a, the heading copy (1) 221b, and the heading copy (2) 221c. The text candidates 231a and 231b are examples of the element to be added and are examples of the first candidate of the character string.

The reception section 11 determines whether or not an operation of selecting the operation target field 221 is received from the user terminal (S5). For example, in a case where the reception section 11 receives an operation of selecting the main copy 221a as the operation target field 221 (S5: Yes), the display control section 13 reads the text candidates 231a and 231b corresponding to the main copy 221a from the text table 23 and displays the text selection window 231 including the text candidates 231a and 231b on the text selection screen 230 (S6).

The display control section 13 reads the text candidate “fishing fair now open”, the text candidate “fishing fair! now open”, . . . associated with the purpose “fishing fair” and the field name “main copy” and inserts the text candidates in the text selection window 231 as the text candidates 231a and 231b.

The reception section 11 receives an operation of selecting the text candidate from the user terminal (S7). That is, the reception section 11 receives an operation of selecting any one of the text candidates 231a and 231b displayed on the text selection window 231 and operation of the “OK button” 232. An assumption that the text candidate “fishing fair! now open” 231b is selected as the text to be inserted in the main copy 221a is made.

The creation section 14 performs a process such as changing the font size on the selected text candidate 231b based on the constraint corresponding to the field name of the layout image information table 24 (S8).

The display control section 13 creates the post-processing text candidate selection screen 240 including the layout image 220a and a text candidate selection window 241 and displays the post-processing text candidate selection screen 240 on the display unit of the user terminal based on the document image 28 and the screen information 25 (S9).

FIG. 9 is a diagram illustrating one example of the post-processing text candidate selection screen 240. The post-processing text candidate selection screen 240 includes the layout image 220a, the post-processing text candidate selection window 241 including a plurality of post-processing text candidates “fishing fair! now open” 241a and 241b processed using different methods based on the constraint, an “OK” button 242 for deciding a selected post-processing text candidate, and a “cancel” button 243 for canceling selection of the post-processing text candidate. For example, an assumption that the text candidate 241a is processed by increasing the font size of one part from the other part and the text candidate 241b is processed to have an identical font size is made. The post-processing text candidates 241a and 241b are examples of the corrected element and are examples of the second candidate of the character string. The post-processing text candidates 241a and 241b and each of the buttons 242 and 243 are selected by pointing with the cursor by operating the input unit of the user terminal.

The reception section 11 receives an operation of selecting the post-processing text candidate (S10). For example, the reception section 11 receives an operation of selecting the post-processing text candidate 241b and operation of the “OK” button 242 from the user terminal. The display control section 13 inserts the selected text candidate 241b in the main copy 221a as illustrated in FIG. 9 and stores the layout image 220a in the storage unit 20 as the document image 28.

The reception section 11 determines whether or not the post-processing text candidate based on the constraint is selected and inserted in each operation target field 221 for all operation target fields 221 (S11).

In a case where the reception section 11 determines that the selected post-processing text candidate is inserted in all operation target fields 221 (S11: Yes), the display control section 13 inserts elements that are fixed information and corresponding to the operation target exclusion fields 222 and 223, displays the created document on the display unit of the user terminal, stores the created document in the storage unit 20 as the document image 28, and finishes the process (S12). Specifically, the display control section 13 reads the store ID, the store name, the address, the map, and the like corresponding to the user ID from the user table 27 as fixed information and inserts the store name in the store name 222a and inserts the address and the map in the address information 222b. Then, the completed document is used as a paper document or an electronic document in the user terminal.

In a case where the reception section 11 determines that the selected post-processing text candidate is not inserted in all operation target fields 221 (S11: No), the reception section 11 receives selection and insertion of the text candidate for the operation target field 221 in which the text candidate is not inserted (S5).

For example, in a case where the reception section 11 receives selection of the heading copy (1) 221b as the operation target field 221 (S5: Yes), the display control section 13 refers to the text table 23, creates a text candidate “reel campaign” 251a by inserting the object name “reel” in the part (a) of the text candidate “a . . . (a) . . . campaign” corresponding to the purpose “fishing fair” and the field name “heading copy”, creates a text candidate “reel sale” 251b by inserting the object name “reel” in the part (a) of the text candidate “a . . . (a) . . . sale”, and displays the text selection screen 250 including a text selection window 251 including the text candidates “reel campaign” 251a and “reel sale”251b on the display unit of the user terminal (S6).

FIG. 10 is a diagram illustrating one example of the text selection screen 250 displayed on the display unit of the user terminal. The text selection screen 250 includes the layout image 220a, the text selection window 251 including the text candidates 251a and 251b corresponding to the heading copy (1) 221b, an “OK” button 252 for deciding the selected text candidate, and a “cancel” button 253 for canceling selection of the text candidate. An assumption that the text candidate “reel campaign” 251a is selected is made (S7). The text candidates 251a and 251b and each of the buttons 252 and 253 are selected by pointing with the cursor by operating the input unit of the user terminal.

The creation section 14 performs a process of changing the font size or the like on the selected text candidate 251a based on the constraint corresponding to the field name of the layout image information table 24 (S8).

The display control section 13 creates the post-processing text candidate selection screen 260 including the layout image 220a and a text candidate selection window 261 and displays the post-processing text candidate selection screen 260 on the display unit of the user terminal based on the document image 28 and the screen information 25 (S9).

FIG. 11 is a diagram illustrating one example of the post-processing text candidate selection screen 260. The post-processing text candidate selection screen 260 includes the layout image 220a, the text candidate selection window 261 including a plurality of post-processing text candidates “reel campaign” 261a and 261b processed using different methods based on the constraint, an “OK” button 262 for deciding the selected post-processing text candidate, and a “cancel” button 263 for canceling selection of the post-processing text candidate. The post-processing text candidates 261a and 261b and each of the buttons 262 and 263 are selected by pointing with the cursor by operating the input unit of the user terminal. In a case where the text candidate 261a is selected, the display control section 13 stores the layout image 220a in the storage unit 20 as the document image 28.

A process for the heading copy (2) 221c is the same as the process for the heading copy (1) 221b. Thus, a description of the process will not be repeated. The document illustrated in FIG. 2 is completed in the above manner.

(2) In Case of Receiving Purpose and Text

Hereinafter, differences from (1) In Case of Receiving Purpose and Image will be generally described. In step S1, the reception section 11 receives the purpose and the text together with the user ID from the user terminal.

In step S6, the display control section 13 displays the text selection window 231 including the text candidate on the text selection screen 230. The creation section 14 processes the text received in step S1 in accordance with the purpose, and the display control section 13 displays the post-processing text on the text selection window 231. For example, in a case where the purpose is a Western style, the processing of the text executed by the creation section 14 includes a process of translating a Japanese text (for example, otanjyoubi omedetou) into English (for example, Happy Birthday). For example, machine learning may be used for translation of the text.

### Second Exemplary Embodiment

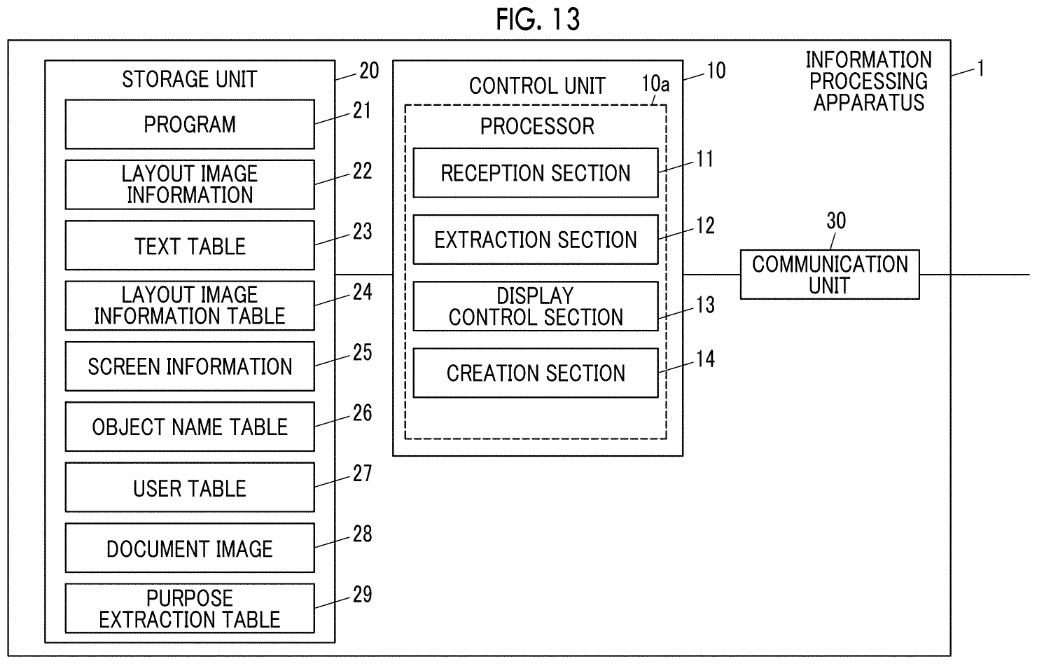

FIG. 13 is a block diagram illustrating a configuration example of an information processing apparatus according to a second exemplary embodiment of the present invention. The present exemplary embodiment is obtained by adding a function of extracting the purpose based on the object name extracted from the image to the first exemplary embodiment. Hereinafter, differences from the first exemplary embodiment will be generally described.

The storage unit 20 of the information processing apparatus 1 stores the program 21, the layout image information 22, the text table 23 (refer to FIG. 3), the layout image information table 24 (refer to FIG. 4), the screen information 25, the object name table 26 (refer to FIG. 5), the user table 27 (refer to FIG. 6), and the document image 28 in the same manner as the first exemplary embodiment and further stores a purpose extraction table 29.

The purpose extraction table 29 includes fields such as “object name”, “purpose”, and “probability”. The object name extracted from the image using, for example, machine learning is recorded in “object name”. A plurality of purposes that are derivable from the object name are recorded in “purpose”. A probability corresponding to the purpose is recorded in “probability”.

The extraction section 12 extracts the object name from the image and extracts the purpose by referring to the purpose extraction table 29 based on the extracted object name. The number of object names used in the case of extracting the purpose is not limited to one and may be plural. In a case where the number of object names used in the case of extracting the purpose is one, the extraction section 12 may extract the purpose having the highest possibility. In a case where the number of object names used in the case of extracting the purpose is plural, the extraction section 12 may extract the purpose having a higher probability. For example, in a case where two object names are reel and sunglasses, and the probability of the purpose “fishing fair” acquired from reel is 80% and the probability of a purpose “summer event” acquired from sunglasses is 60%, the extraction section 12 may extract the purpose “fishing fair” having a higher probability. A plurality of purposes having higher probabilities may be extracted, and the plurality of extracted purposes may be displayed on the display unit of the user terminal as candidates in order for the user to select the purpose.

Operation of Second Exemplary Embodiment

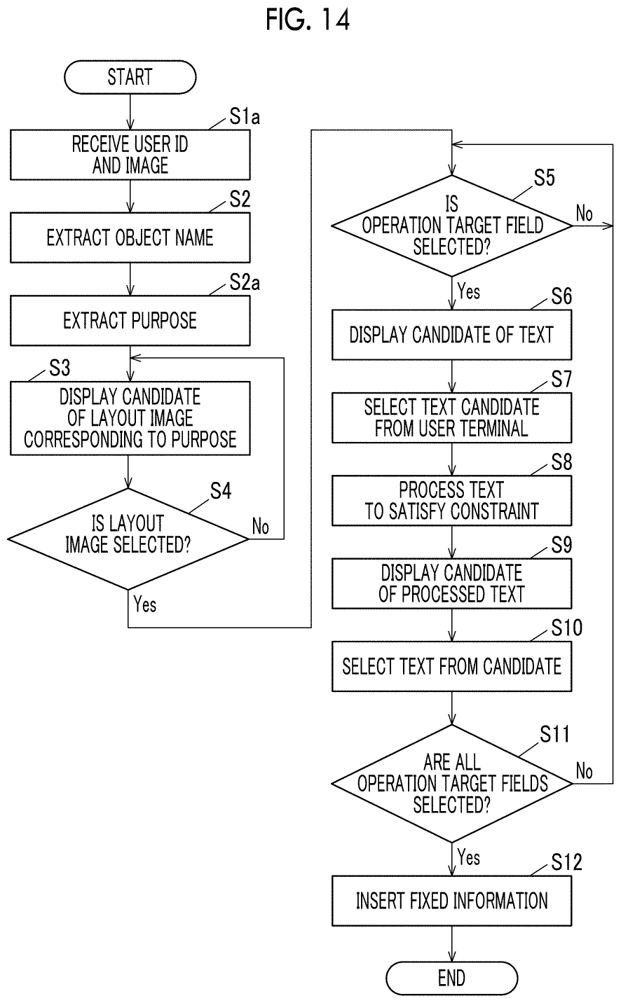

Next, one example of operation of the information processing apparatus 1 according to the second exemplary embodiment of the present invention will be described with reference to FIG. 14. FIG. 14 is a flowchart illustrating one example of operation of the information processing apparatus 1 according to the second exemplary embodiment of the present invention. Differences from the first exemplary embodiment will be generally described.

The reception section 11 receives the image together with the user information from the user terminal (S1a). For example, an assumption that two photographs in which fishing tools are captured are received as the image is made.

The extraction section 12 assigns the image ID to the photograph received by the reception section 11, extracts the object name from the photograph, and records the image ID, the photo, and the extracted object name in the object name table 26 in association with each other in the same manner as the first exemplary embodiment (S2). For example, an assumption that reel and sunglasses are extracted from the two photographs, respectively, as the object name is made.

The extraction section 12 extracts the purpose from the purpose extraction table 29 based on the extracted object name (S2a). An assumption that “fishing fair” is extracted from the object names “reel” and “sunglasses” as the purpose is made. Steps from step S3 are the same as the first exemplary embodiment. Thus, descriptions of the steps will not be repeated.

### Modification Example 1

While the extraction section 12 extracts the purpose from the received photograph in the second exemplary embodiment, the extraction section 12 may extract the purpose from the text. For example, in a case where a text including a word “reel” is received, the extraction section 12 may extract “fishing fair” from the purpose extraction table as the purpose based on the word “reel” included in the text. In this case, the purpose extraction table includes fields such as “word”, “purpose”, and “probability”, and the word, the purpose, and the probability are recorded using, for example, machine learning.

### Modification Example 2

For example, in a case where the type of photograph is analyzed to be a type of Western style, Western style may be extracted as the purpose. A Japanese text (for example, otanjyoubi omedetou) provided from the user may be translated into a plurality of foreign languages such as English (for example, Happy Birthday) and French (for example, Joyeux anniversaire) and displayed as the text candidate, and the user may select the text candidate.

### Modification Example 3

The extraction section 12 may extract the purpose from the attribute information such as the age, age group, sex, hobby, preference, job, and company characteristics (in a case where the order placer is a company) of the order placer, the creator, or the recipient of the document.

### Modification Example 4

While the text is extracted from the text table 23 in each of the exemplary embodiments, various dictionaries such as a term dictionary may be used instead of the table. For example, a dictionary from which the catchphrase such as a keyword that is recorded in accordance with the text and includes the text may be read may be used. For example, the extraction section may extract “image of summer” as the purpose from a keyword that recalls summer, and the creation section may create a candidate by converting a word of summer included in the text provided from the user into a text highlighted by the font size or the like.

### Modification Example 5

The extraction section may acquire information on the sex of the user as the recipient by referring to the user table in which the attribute information of the user is recorded using the user ID, and may extract “for women” or “for men” as the purpose of the document in accordance with the sex of the recipient. In addition, the extraction section may acquire information on the sex and the age of the user from the user table and may extract “cute” for a young woman or “strong” for a young man as the purpose of the document. For example, the creation section may create the candidate by converting the text (for example, otanjyoubi omedetou) provided from the user into a text (for example, pinkuirono otanjyoubi omedetou) for the extracted purpose “for women”.

### Modification Example 6

While the information processing apparatus as the server is described in each of the exemplary embodiments, the user terminal may function as the information processing apparatus by downloading the program from the server. In this case, the server may perform a part of the sections such as the extraction section 12.

While the exemplary embodiments of the present invention are described above, the exemplary embodiments of the present inventions are not limited to the above exemplary embodiments and may be subjected to various modifications and implementations without changing the gist of the present invention.

A part or the entire of each section of the processor 10a may be configured with a hardware circuit such as a reconfigurable circuit (field programmable gate array (FPGA)) or an integrated circuit for a specific application (application specific integrated circuit (ASIC)).

A part of the constituents of the exemplary embodiments may be removed or changed without changing the gist of the present invention.

Addition, removal, changing, switching, and the like of steps may be performed in the flow of the exemplary embodiments without changing the gist of the present invention. The program used in the exemplary embodiments may be provided as a recording on a computer readable recording medium such as a CD-ROM. The program used in the exemplary embodiments may be stored in an external server such as a cloud server and used through the network.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a display control section that performs control for displaying a candidate for an element to be added or a corrected element based on an element constituting a document and information related to a purpose of use of the document to be created.

2. The information processing apparatus according to claim 1,
wherein the information related to the purpose of use is information extracted from the provided element.

3. The information processing apparatus according to claim 1,
wherein the information related to the purpose of use is information extracted from classification information for classifying a person related to the document.

4. The information processing apparatus according to claim 1,
wherein the element to be added is an element of a different type from the provided element.

5. The information processing apparatus according to claim 2,
wherein the element to be added is an element of a different type from the provided element.

6. The information processing apparatus according to claim 3,
wherein the element to be added is an element of a different type from the provided element.

7. The information processing apparatus according to claim 1,
wherein the corrected element is an element corrected in accordance with a region in which the element is inserted.

8. The information processing apparatus according to claim 2,
wherein the corrected element is an element corrected in accordance with a region in which the element is inserted.

9. The information processing apparatus according to claim 3,
wherein the corrected element is an element corrected in accordance with a region in which the element is inserted.

10. The information processing apparatus according to claim 1, further comprising:
a creation section that, in a case where the element to be added or the corrected element is a character string, creates a first candidate of the character string based on the information related to the purpose of use and creates a second candidate of the character string by changing an attribute of the character string in accordance with a region in which the element is inserted in the first candidate of the character string,
wherein the display control section performs control for displaying the second candidate of the character string.

11. The information processing apparatus according to claim 2, further comprising:
a creation section that, in a case where the element to be added or the corrected element is a character string, creates a first candidate of the character string based on the information related to the purpose of use and creates a second candidate of the character string by changing an attribute of the character string in accordance with a region in which the element is inserted in the first candidate of the character string,
wherein the display control section performs control for displaying the second candidate of the character string.

12. The information processing apparatus according to claim 3, further comprising:
a creation section that, in a case where the element to be added or the corrected element is a character string, creates a first candidate of the character string based on the information related to the purpose of use and creates a second candidate of the character string by changing an attribute of the character string in accordance with a region in which the element is inserted in the first candidate of the character string,
wherein the display control section performs control for displaying the second candidate of the character string.

13. The information processing apparatus according to claim 4, further comprising:
a creation section that, in a case where the element to be added or the corrected element is a character string, creates a first candidate of the character string based on the information related to the purpose of use and creates a second candidate of the character string by changing an attribute of the character string in accordance with a region in which the element is inserted in the first candidate of the character string,
wherein the display control section performs control for displaying the second candidate of the character string.

14. The information processing apparatus according to claim 5, further comprising:
a creation section that, in a case where the element to be added or the corrected element is a character string, creates a first candidate of the character string based on the information related to the purpose of use and creates a second candidate of the character string by changing an attribute of the character string in accordance with a region in which the element is inserted in the first candidate of the character string,
wherein the display control section performs control for displaying the second candidate of the character string.

15. The information processing apparatus according to claim 6, further comprising:
a creation section that, in a case where the element to be added or the corrected element is a character string, creates a first candidate of the character string based on the information related to the purpose of use and creates a second candidate of the character string by changing an attribute of the character string in accordance with a region in which the element is inserted in the first candidate of the character string,
wherein the display control section performs control for displaying the second candidate of the character string.

16. The information processing apparatus according to claim 7, further comprising:
a creation section that, in a case where the element to be added or the corrected element is a character string, creates a first candidate of the character string based on the information related to the purpose of use and creates a second candidate of the character string by changing an attribute of the character string in accordance with a region in which the element is inserted in the first candidate of the character string,
wherein the display control section performs control for displaying the second candidate of the character string.

17. The information processing apparatus according to claim 8, further comprising:
a creation section that, in a case where the element to be added or the corrected element is a character string, creates a first candidate of the character string based on the information related to the purpose of use and creates a second candidate of the character string by changing an attribute of the character string in accordance with a region in which the element is inserted in the first candidate of the character string,
wherein the display control section performs control for displaying the second candidate of the character string.

18. The information processing apparatus according to claim 9, further comprising:
a creation section that, in a case where the element to be added or the corrected element is a character string, creates a first candidate of the character string based on the information related to the purpose of use and creates a second candidate of the character string by changing an attribute of the character string in accordance with a region in which the element is inserted in the first candidate of the character string,
wherein the display control section performs control for displaying the second candidate of the character string.

19. The information processing apparatus according to claim 10,
wherein the attribute of the character string is any of the number of characters, a font type, a font size, or a type of highlight.

20. A non-transitory computer readable medium storing a program causing a computer to function as:
a display control section that performs control for displaying a candidate for an element to be added or a corrected element based on an element constituting a document and information related to a purpose of use of the document to be created.
